(19) United States
(12) Patent Application Publication
(10) Pub. No.: US 2026/0168906 A1
(43) Pub. Date: Jun. 18, 2026

(54) SCRAPE TESTING DEVICE TO CHARACTERIZE SAMPLE FORMULATIONS

(71) Applicant: Dow Global Technologies LLC, Midland, MI (US)

(72) Inventors: Yinglong Chen, Lake Jackson, TX (US); Larry Dotson, Midland, MI (US); Kyle Atkins, Midland, MI (US); Jörn Breckwoldt, Hamburg (DE); William Weatherholtz, Midland, MI (US)

(21) Appl. No.: 19/119,821

(22) PCT Filed: Oct. 12, 2023
(86) PCT No.: PCT/US2023/076691

§ 371 Date: Apr. 10, 2025

Related U.S. Application Data
(60) Provisional application No. 63/421,207, filed on Nov. 1, 2022.

(51) Int. Cl. G01N 3/46; G06F 3/041; G06F 3/044

(52) U.S. Cl. CPC G01N 3/46; G06F 3/04144; G06F 3/044

(57) ABSTRACT

Devices for scrape testing a sample include: a sample holder for holding the sample; a scraping blade assembly system for testing the physical characteristics of the sample that include a blade assembly, a propulsion system for moving the blade assembly relative to the sample holder, and a force sensor for measuring the force that the blade assembly experiences when scraping against the sample. Methods include placing a sample in a scrape testing device that includes a sample holder for holding the sample; a scraping blade assembly system for testing the physical characteristics of the sample that include: a blade assembly, a propulsion system for moving the blade assembly relative to the sample holder, and a force sensor for measuring the force that the blade assembly experiences when scraping against the sample; and operating the testing device and determining at least one force measurement during movement of the blade assembly.

### FIELD

Embodiments relate to devices for scrape testing of samples to determine characterizing physical properties of samples of slurries and other settable compositions.

### INTRODUCTION

Gypsum plasters are used to create a wide variety wall coverings and may be formulated with various additives that change the texture and appearance of the final set or cured product. Plasters are prepared as a slurry containing a suspension of solids in water or other fluid, which has physical properties that differ from purely solid or liquid systems. Plasters are applied in multiple stages, typically to vertical surfaces, which require the plaster material to exhibit cohesive and sag resistant properties. In addition, plaster formulations are often selected on the basis of tactile features experienced by a craftsman during application, such as workability and stickiness, but are less easily quantified.

Established standard testing methods for gypsum plaster slurries, such as ASTM C472-20, provide insight into setting time, compressive strength, and density, but lack the ability to characterize the complex material interactions that occur during application to a substrate that manifest during troweling and screeding. However, such testing methods typically focus on set time and physical properties such as compressive strength and density, and may not adequately represent the nuance of experienced workability during application.

Currently testing methods for gauging subjective measures of application performance such as workability and internal cohesiveness (“stickiness”) require reproducing work site conditions based on conditions that mimic the application to vertical surfaces and assessing the fresh plaster from experience, require large volumes of materials, along with the associated time and material costs.

### SUMMARY

In an aspect, devices for scrape testing a sample including: a sample holder for holding the sample; a scraping blade assembly system for testing the physical characteristics of the sample that include a blade assembly, a propulsion system for moving the blade assembly relative to the sample holder, and a force sensor for measuring the force that the blade assembly experiences when scraping against the sample.

In another aspect, methods include placing a sample in a scrape testing device that includes a sample holder for holding the sample; a scraping blade assembly system for testing the physical characteristics of the sample that includes a blade assembly, a propulsion system for moving the blade assembly relative to the sample holder, and a force sensor for measuring the force that the blade assembly experiences when scraping against the sample; and operating the testing device and determining at least one force measurement during movement of the blade assembly.

### BRIEF DESCRIPTION OF THE FIGURES

FIG. 1 is schematic depicting an isometric view of a scrape testing device in accordance with the present disclosure.

FIG. 2 is schematic depicting a side view of a scrape testing device in accordance with the present disclosure.

FIG. 3 is schematic depicting an isometric view of a scrape testing device in accordance with the present disclosure showing operation in which the sample holder is horizontally oriented.

FIG. 4 is a graphical representation of force as a function of displacement for samples from a first run scrape measurement.

FIG. 5 is a graphical representation of force as a function of displacement for samples from a first run scrape measurement.

### DETAILED DESCRIPTION

Embodiments disclosed herein relate to scrape testing devices for determining the physical properties of slurries and other settable compositions. Devices for scrape testing disclosed herein may include a sample holder for holding the sample, and a scraping blade assembly system for testing the physical characteristics of the sample that includes a blade assembly, a propulsion system for moving the blade assembly relative to the sample holder, and a force sensor for measuring the force that the blade assembly experiences when scraping against the sample.

Scrape testing methods disclosed herein may be generally useful to characterize compositions having mixed liquid and solid properties, particularly for plaster formulations that are spread or applied to surfaces (e.g., vertical, horizontal). Testing may involve measuring physical properties of a plaster slurries and other settable compositions, particularly properties related to tactile elements such as stickiness and workability during applications that may not be adequately described by standard methods such as ASTM C-472-20 or flowability measures such as European Standards test UNE EN 13279-2. Testing methods disclosed herein may utilize relatively small scale testing amounts (e.g., 1 kg to 2 kg), particularly when compared to field trials utilizing 80 kg to 100 kg of material.

Plaster formulations are prepared by mixing the particulate component (e.g., gypsum) with a suitable aqueous fluid, which generates a slurry. The presence of water in the slurry also initiates the setting reaction that forms geopolymer (e.g., calcium sulfate dihydrate), which leads to increases in mechanical properties such as compressive strength. The plaster slurry is applied prior to completion of the setting reaction, which requires gathering the material, smoothing it on the substrate, and level by screeding and/or sanding. During this application process, the cohesive properties of the material provide unique feedback in terms of “workability” that relate to the ability of the plaster to be gathered, applied and spread, wherein too thin of a consistency results in sagging or disintegrating and too thick of a consistency results in difficult application and surface adhesion.

Scrape testing methods described herein quantify forces measured as a blade (or trowel) is displaced across the surface of a sample. Force measurements obtained during scrape testing (e. g, friction, resistance) provide information regarding structure/performance of the formulation components, which may be converted by known physical relationships to workability, stickiness, and other experiential measurements useful in determining the performance of plasters, cements, and other materials. Force measurements obtained by methods disclosed herein may include other relevant physical properties such as staying power during spraying, screeding during leveling, plasticity, pilling behavior during cure, and the like. Characterization of the desired physical measurements may then be used to customize plaster formulations to control dimensional stability and reduce sag and other issues, such as by adjusting the ratio of water to particulate solids (e.g., gypsum) or the concentration of various additives, including polymeric fluidizers such as starches, cellulose ethers, polycarboxylate ethers, starch ethers, acrylamides, polyacrylamides, acrylics, polyacrylic or polymethacrylic acids, and the like.

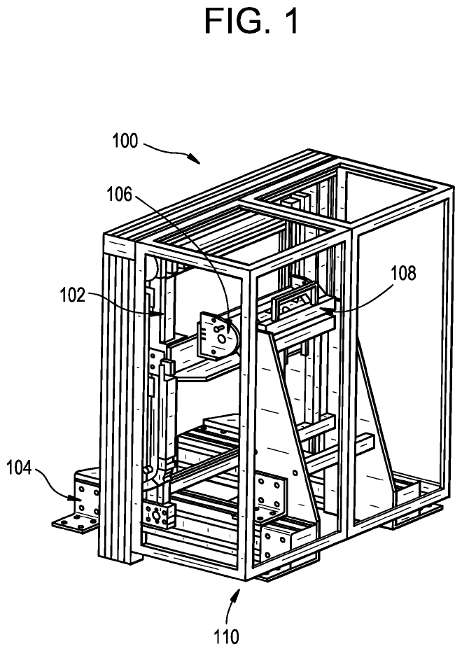

Devices disclosed herein may include a mechanism for securing a sample and a scraping blade assembly for performing scrape testing on the sample. The blade assembly includes a force sensor that provides quantitative measurements of the frictional force on the blade during contact with the sample that provides information regarding bulk properties of the slurry such as stickiness and workability. FIGS. 1-3 provide an illustration of a scrape testing device 100 in accordance with the present disclosure. The device 100 includes a propulsion system 102 (shown as a belt-drive gantry), a base 104 that provides stability during operation, and a blade assembly 106 movably mounted to the propulsion system with respect to a sample holder 108. The propulsion system 102 may be a gantry as shown in FIG. 1, but any suitable mechanism capable of engaging the blade assembly 106 with the sample holder 108 may be used including propulsion systems utilizing a centralized support or telescoping members.

The propulsion system 102 can drive the blade assembly 106 at different rates. Rates may be dependent on application and sample composition, but may range from 0.01 m/s to 2 m/s, such as from 0.01 m/s, 0.02 m/s, or 0.025 m/s, to 0.5 m/s, 1 m/s, 1.5 m/s, or 2 m/s. In some cases, the propulsion system 102 drives the blade assembly at a rate of at least 0.5 m/s. A propulsion system may be operated at continuous or variable rates during testing.

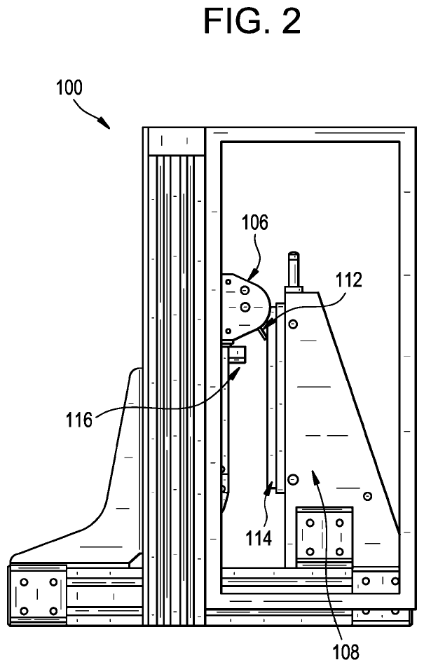

With respect to FIG. 2, base 104 serves to fix the sample holder 108 and sample 114 at a relative position between the blade 112 and sample 114. The angle of the blade 112 may be fixed or variable, and may be at an angle from the vertical ranging from 25° to 50°, and in some case may be at 30°. Blade assembly 106 may include a mechanism that enables quick installation/uninstallation of the scraping blade 112 and easy adjustment of blade's 112 contact angle with respect to the sample 114 surface.

Samples may be affixed or applied to sample holder 108 in a substantially vertical or horizontal orientation. For gypsum formulations and other slurries, samples may be applied to a horizontal sample holder 108 at a suitable thickness, such as a thickness ranging from 10 mm to 15 mm, depending on the particular formulation and/or substrate. However, thinner or thicker coatings may be applied as the application warrants. Samples can be applied to sample holder 108 by any suitable means, such as by spraying, spreading, hand troweling, dry casting, wet casting or by extrusion to the necessary thickness, depending on the material and desired layer thickness.

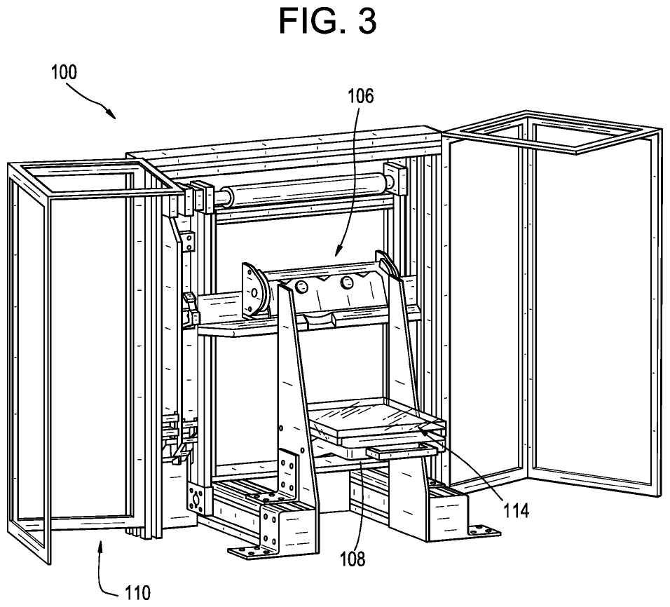

As shown in FIG. 3, the sample holder 108 may be adjustable from a substantially horizontal orientation to a substantially vertical orientation, such that sample 114 may be installed (e.g., affixed or clamped thereupon) and/or coated onto sample holder 108, which is then oriented substantially vertically and into position with blade assembly 106 during operation of the propulsion system 102.

The moving blade assembly 106 contains a fixture that connects to the propulsion system 102 (such as crossbar of a gantry), a force sensor 116 that measures the frictional force in parallel to the scraping motion of the blade. Measurement methods may include the calculation of various forces associated with the movement of blade assembly 106, which may be registered and/or recorded using a device for calculating force, such as a force sensor 116 that converts sensed movement and displacement to force measurements using established physical principles. Force sensors 116 may measure and calculate force in Newtons (N) and may have an operating range suitable for the application, including a range of 0 to 50 N, 40 N, or 25 N. In some cases, the force sensor is a load cell for detecting forces in a range up to 30 N.

The testing device 100 may also include a safety enclosure 110 that prevents inadvertent access to the blade assembly 106 and the sample holder 108, particularly during operation. The safety enclosure 110 may include a shield or other obstruction that prevents access, which may include a full cabinet as shown in FIG. 1 or modified versions thereof. Safety elements may also include sensors for detecting force limits and other obstructions that are manually controlled or automated by computer system. Also include various alarms and stop limits for travel of the propulsion system and/or force limits for operation during testing.

Device 100 may be operated by a control box (not shown), which may control operation and may report or display results. The control panel provides the electrical control options to operate the whole device including an automatic mode that the gantry system will drive the blade assembly to scrape the gypsum surface at a designated contact depth, angle and speed automatically and then return to its original position, as well as a manual mode that allows the move the blade assembly to any position needed.

A local control system may operate the propulsion system 102 and other device features, and may coordinate the relay information from the force sensor 116 to a computer system that calculates force on the blade assembly as a function of displacement. Control systems for operation may be integrated into or wired to the device 100. Control of the device may utilize wired or wireless interfaces, such as IEEE 802.11 (Wifi), BLUETOOTH®, global positioning system (GPS), or a wide-area wireless interface. In some cases, control of the device and force sensor processing may be done by a computer system, such as calculating and displaying force on the blade assembly as a function of displacement to determine stickiness, workability and other rheological properties.

Measurements provide by testing devices in accordance may be made with respect to a comparative sample or standard. In some cases scrape testing devices disclosed herein may be combined with other measurements such as parallel plate rheometry or tribometry or other rheological measurements of the formulated /aster/ mortar to measure the viscoelastic properties and application performance.

Devices may be dimensioned for relatively small scale testing (e.g., 1 kg or 2 kg), and may be approximately 3′×3′×2′. However, it is envisioned that the testing device may be dimensioned for smaller (e.g., bench top) or larger scales.

Testing methods may include performing at least two runs (e.g., a first run and a second run) in which the blade assembly is passed over a sample placed on the sample holder. After the blade assembly reaches the end point of the displacement measurement, the blade assembly is reset (which may involve raising the blade from the contact surface) for additional measurements or sample removal. During measurement, the blade is engaged at a predetermined depth into the sample (e.g., 1 mm) and a first run is performed at a selected rate to remove surface features, and improve reproducibility in the second testing run. In the second run, the propulsion system is reset and the blade is adjusted an additional depth into the sample (e.g., 1 mm) and again drawn at a selected rate (which may differ from the first run). The force and displacement (may also include other measurements such as weight on blade) are recorded and used to determine one or more physical properties. The second run provides more consistent measurements due to the relatively homogenous surface, and is used to compare performance against a standard, between samples, and/or across runs. Physics-based techniques are then used to calculate various physical parameters such as tackiness, viscosity, and rheological factors.

In some cases, testing methods may include placing a sample in a scrape testing device having a sample holder for holding the sample, a scraping blade assembly system for testing the physical characteristics of the sample including, a blade assembly, a propulsion system for moving the blade assembly relative to the sample holder, and a force sensor for measuring the force that the blade assembly experiences when scraping against the sample; and operating the testing device and determining at least one force measurement during movement of the blade assembly.

While gypsum plaster slurries and renders are discussed in the foregoing disclosure, it is envisioned that the device and methodologies may be adapted to other applications involving settable mixtures in which workability can affect application, appearance, and durability on vertical or horizontal applications. Alternative materials may include cementitious materials, conventional concrete, sorel cements, mortar, stucco, synthetic stucco, plaster or any other, polymer modified cements and plasters, polymer coatings, and the like. In some cases, testing methods may be applied to polymer modified plasters and cementitious materials containing polymer additives such as thermoplastic polymers, thermosetting polymers, elastomeric polymers, latex polymers, and the like.

### EXAMPLES

The following example is provided to illustrate the embodiments of the invention, but are not intended to limit the scope thereof.

In this example, gypsum formulations containing various cellulose ethers were prepared and analyzed using a scrape test in accordance with the present disclosure to quantify workability of the compositions during application. Gypsum base material was obtained from a commercial supplier, divided and the two resulting portions were combined, respectively, with separate grades of cellulose ether. Cellulose ether grades were defined by distinct cross-over values (COV), which characterize the gel-like behavior of the mixtures, where lower values are often associated with increased gel-character and unfavorable workability under job site conditions. COV was characterized in aqueous solution (1%) by oscillation experiment as the intersection of intersection of the storage modulus G′=loss modulus G″.

In this example, samples were prepared from a mixture of gypsum base material and blended with a 1 wt % solution of cellulose ether. Sample A was formulated with cellulose ether 1 having a COV of 0.4 rad/s, and Sample B was formulated with a cellulose ether 2 having a COV of 0.17 rad/s. The number designation (e.g., Sample A1, A2, etc.) indicates repeat runs for a formulation in a two-stage scraping test in which Samples A and B were prepared and separately applied to a horizontal a horizontal sample holder up to ˜15 mm thick by spraying or spreading. The sample holder is then raised into a vertical position within the testing device.

The testing occurs in two stages. In the first stage, the blade is adjusted 1 mm into the sample and drawn at a speed of 0.5 m/s for 300 mm of vertical displacement. During the measurement the change in force on the blade was measured by a load cell equipped to the blade assembly and recorded. This first stage removes surface features, and improves reproducibility in the second testing stage. In the second stage, the gantry was reset and the blade was adjusted 1 mm further into the respective samples and again drawn at a speed of 0.5 m/s for 300 mm of vertical displacement. The second stage provides more consistent measurements and is used to compare performance between samples and across runs.

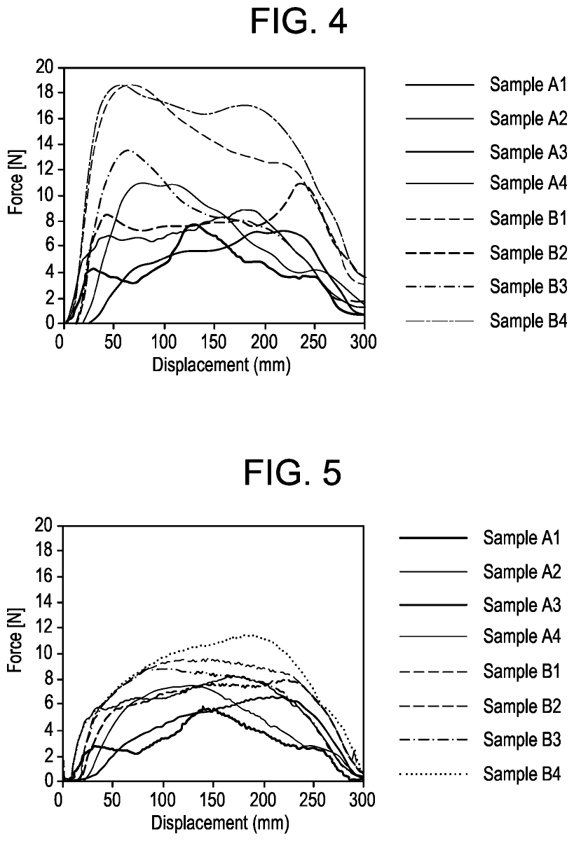

Results for the first stages are shown in FIG. 4 with force (N) as a function of displacement (mm) at a blade speed of 60 in/min (0.025 m/s). The results indicate that Sample B runs (cellulose ether COV=0.17 rad/s) consistently provides higher resistance to scraping, when compared to Sample A (cellulose ether COV=0.17 rad/s). Further, the reduced workability of Sample B show that the initial application of the formulation to the sample holder is irregular as indicated by the high degree of variation between the runs (Samples B1-B4), which may be aggregation properties of the sample and increased adhesion to the testing blade. The characteristic increase of the force measurement is associated with the buildup of material on the blade, while the decrease is associated with the redistribution of the material buildup over sample features generated by the application mechanism. A shown in FIG. 5, a second run was performed and the force as a function of displacement recorded. In the second measurement, lower relative force for Sample A1 to A4 runs was observed with a maximum force ranging from about 6 N to 8 N, while Sample B1 to B4 ranged from about 7.5 N to 12 N. The results enable the selection between cellulose ether products, while also providing a benchmark to modify the formulation by other methods such as adjusting the component ratios or incorporating additives to improve rheology.

While the foregoing is directed to exemplary embodiments, other and further embodiments may be devised without departing from the basic scope thereof, and the scope thereof is determined by the claims that follow.

1. A device for scrape testing a sample, comprising:
a sample holder for holding the sample;
a scraping blade assembly system for testing the physical characteristics of the sample comprising a blade assembly, a propulsion system for moving the blade assembly relative to the sample holder, and a force sensor for measuring the force that the blade assembly experiences when scraping against the sample.

2. The device of claim 1, wherein the propulsion system is an automated gantry.

3. The device of claim 1, wherein the force sensor is a load cell for detecting forces in a range up to 30 N.

4. The device of claim 1, wherein the sample holder holds the sample at a substantially vertical orientation during operation of the propulsion system.

5. The device of claim 1, wherein the sample holder is movable to a substantially horizontal orientation to affix the sample to the sample holder.

6. The device of claim 1, wherein the blade assembly comprises a blade oriented at 30°from the vertical.

7. The device of claim 1, wherein the propulsion system drives the blade assembly at a rate of at least 0.5 m/s.

8. The device of claim 1, wherein the propulsion system drives the blade assembly at a variable rate during testing.

9. The device of claim 1, wherein the force sensor communicates with a computer system that calculates force on the blade assembly as a function of displacement.

10. A method, comprising:
placing a sample in a scrape testing device comprising:
a sample holder for holding the sample;
a scraping blade assembly system for testing the physical characteristics of the sample comprising:
blade assembly,
a propulsion system for moving the blade assembly relative to the sample holder, and
a force sensor for measuring the force that the blade assembly experiences when scraping against the sample; and
operating the testing device and determining at least one force measurement during movement of the blade assembly.
